(19) United States
(12) Patent Application Publication
(10) Pub. No.: US 2007/0250816 A1
(43) Pub. Date: Oct. 25, 2007

(54) Process and method for using real-work statistics for automatically selecting appropriate developer to fix a problem

(75) Inventor: Laura L. Rose, Raleigh, NC (US)

Correspondence Address: HAMILTON & TERRILE, LLP, P.O. BOX 203518, AUSTIN, TX, 78720, US

(73) Assignee: International Business Machines Corporation, Armonk, NY (US)

(21) Appl. No.: 11/406,916

(22) Filed: Apr. 19, 2006

(51) Int. Cl. G06F 9/44

(52) U.S. Cl. 717/124; 717/100

(57) ABSTRACT

A method, apparatus and computer usable medium for selecting a developer for fixing a defect within a component is set forth. The process makes use of previous real-work statistics to select the appropriate developer to help more accurately determine a time-frame to fix the defect. The process enables limiting a selection list to only those developers that are appropriate to fix a particular defect. The process also enables expanding a search for developers to fix the defect to outside an immediate product group.

### BACKGROUND OF THE INVENTION

1. Field of the Invention

The present invention relates in general to the field of computers and similar technologies, and in particular to software utilized in this field. Still more particularly, the present invention relates to using statistics for automatically selecting an appropriate developer to fix a problem.

2. Description of the Related Art

An issue relating to software development relates to fixing defects of the software. When determining a strategy for fixing the defects, daily triage meetings are held to assign an appropriate developer to fix the defect. Developer managers often need to continually attend these meetings to match an appropriate developer skill with a component for which a defect was identified. Often these meetings can loose focus. Time is taken to discuss the defect in more detail than really required, as well as how to fix the defect (which isn't the purpose of the meeting). It would be desirable to provide a process for making these triage meetings more effective.

Identifying an appropriate developer to fix a defect is currently a manual process. Known processes for assigning a developer to fix a defect often look to the last person that touched the code. This is not the most efficient use of our resources. The developer that is first identified may already have a large backlog of defects, may be on vacation, or may be on a customer site, etc. The schedule or defect backlog of the developer is often not considered in the defect ownership assignments. Known defect tracking tools, such as the ClearQuest defect tracking tool, present a list of all the users of the product. The list is not filtered based on developer profile, skill set or availability.

### SUMMARY OF THE INVENTION

In accordance with the present invention, an automated process of selecting a developer for fixing a defect within a component is set forth. The process makes use of previous real-work statistics to select the appropriate developer to help more accurately determine a time-frame to fix the defect. The process enables limiting a selection list to only those developers that are appropriate to fix a particular defect. The process also enables expanding a search for developers to fix the defect to outside an immediate product group.

The automated process for selecting a developer for fixing a component creates developer profiles and component profiles. The developer profiles include a developer skillset, a calendar of developer availability, information regarding how many defects already in the queue of the developer, etc. The component profiles include a skillset desirable for fixing the defect, a typical level of effort to fix similar defects in this area, etc. By creating the appropriate component profiles, the process matches and searches for a list of developers able to fix the problem. The process can also create additional search criteria to priority order the identified developers.

A searcher can identify a search protocol. For example . . . for Component X, the searcher might want to follow the following protocol:

(1) First check Kevin Mooney, David Scott and Joe Brown's availability;

(2) If those specific developers are not available, check all the developers in Dept. A. Find a list of developers that have the appropriate skillset and availability.

(3) If we can't find in Dept A, search Dept. B, C, D.

Search rules used by the process can be flexible. For example, the searcher might set the search rules to automatically identify the first available developer or to limit the results of the search to a pulldown list of the top 5-10 appropriate developers. Either way, because of the profile matches, the list displayed is only of the developers that are capable and available to fix the defect.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary client computer in which the present invention may be implemented;

FIG. 2 illustrates an exemplary server from which software for executing the present invention may be deployed and/or implemented for the benefit of a user of the client computer shown in FIG. 1;

FIG. 3 shows a block diagram of an automated system for selecting a developer to fix a defect;

FIG. 4 shows a flow chart of the operation of the automated system for selecting a developer to fix a defect;

FIG. 5 shows an example screen presentation of the automated system for selecting a developer to fix a defect;

FIG. 6 shows an example screen presentation of the automated system for inputting search criteria;

FIGS. 7a-b show a flow-chart of steps taken to deploy software capable of executing the steps shown and described in FIGS. 3-6;

FIGS. 8a-c show a flow-chart of steps taken to deploy in a Virtual Private Network (VPN) software that is capable of executing the steps shown and described in FIGS. 3-6;

FIGS. 9a-b show a flow-chart showing steps taken to integrate into a computer system software that is capable of executing the steps shown and described in FIGS. 3-6; and

FIGS. 10a-b show a flow-chart showing steps taken to execute the steps shown and described in FIGS. 3-6 using an on-demand service provider.

### DETAILED DESCRIPTION

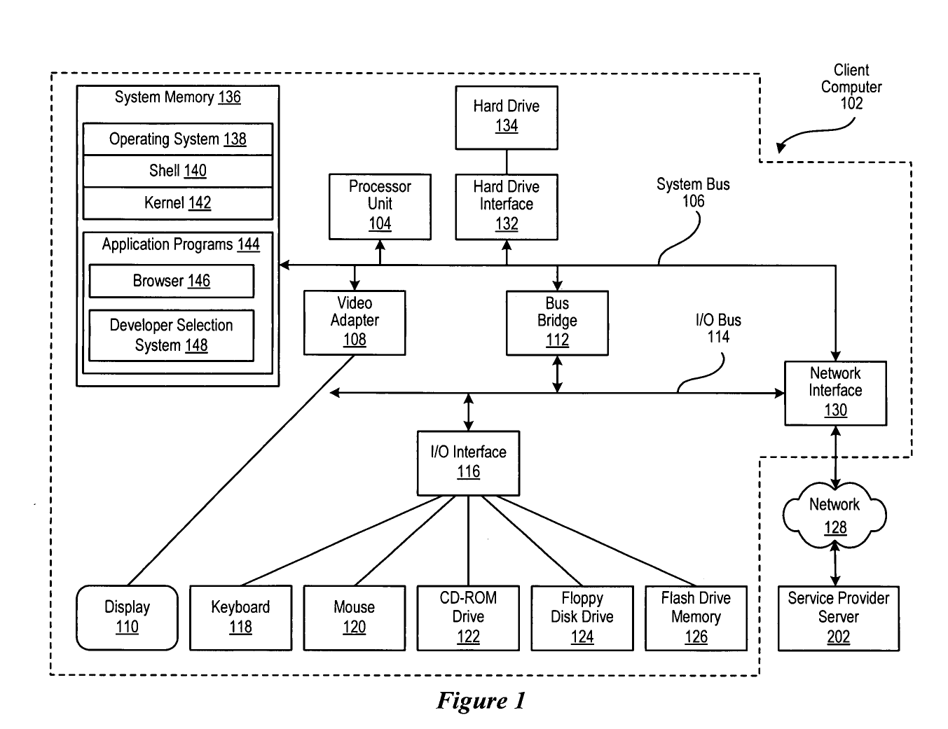

With reference now to FIG. 1, there is depicted a block diagram of an exemplary client computer 102, in which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 416 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN). Using network 128, client computer 102 is able to use the present invention to access service provider server 202.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 202.

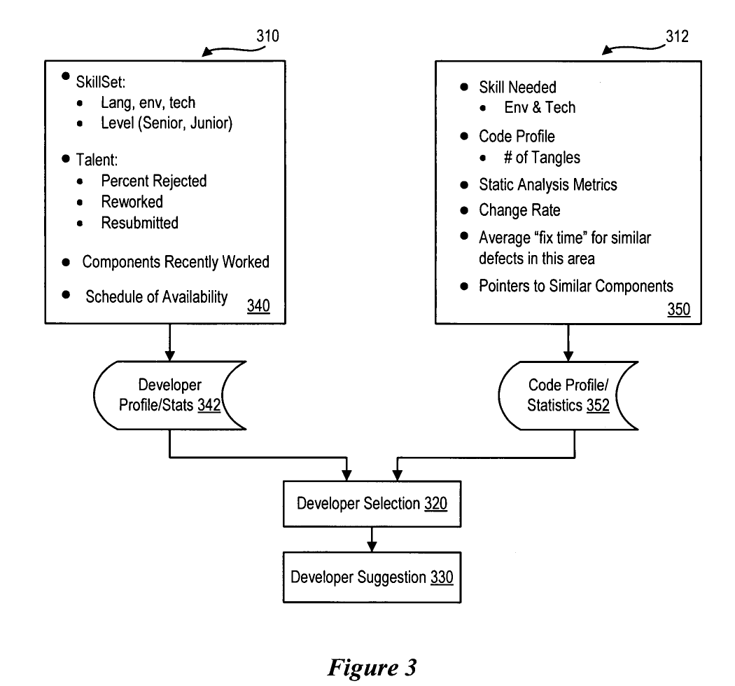

Application programs 144 in client computer 102's system memory also include a developer selection system 148. The developer selection system 148 includes code for implementing the processes described in FIG. 3-6. In one embodiment, client computer 102 is able to download developer selection system 148 from service provider server 202.

The hardware elements depicted in client computer 102 are not intended to be exhaustive, but rather are representative to highlight essential components required by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

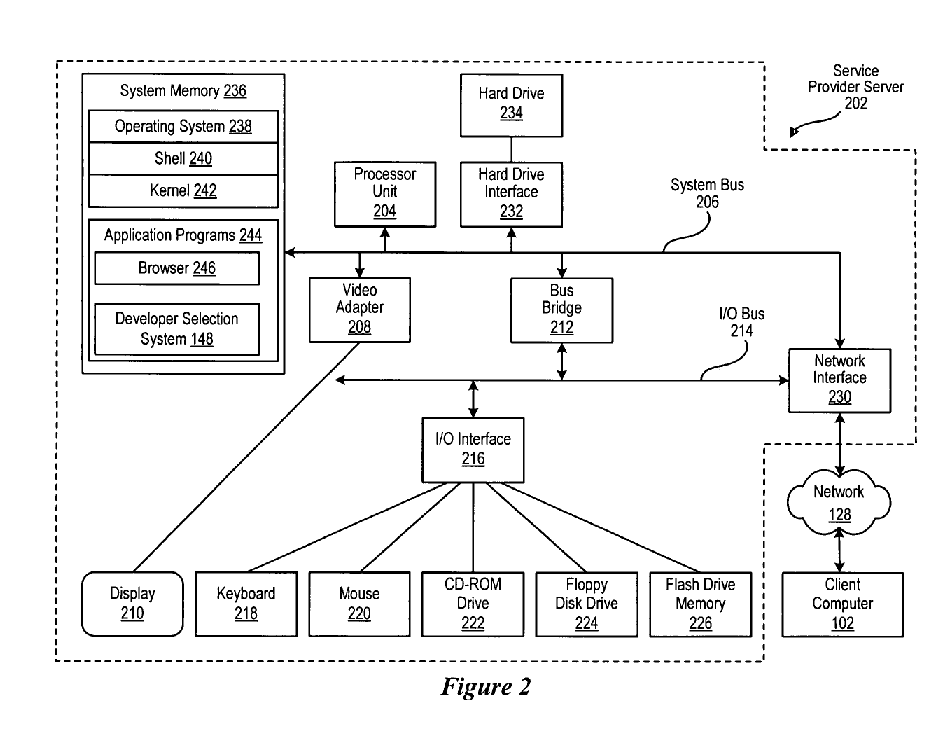

As noted above, developer selection system 148 can be downloaded to client computer 202 from service provider server 202, shown in exemplary form in FIG. 2. Service provider server 202 includes a processor unit 204 that is coupled to a system bus 206. A video adapter 208 is also coupled to system bus 206. Video adapter 208 drives/supports a display 210. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Service provider server 202 is able to communicate with client computer 102 via network 128 using a network interface 230, which is coupled to system bus 206. Access to network 128 allows service provider server 202 to execute and/or download the developer selection system 148 to client computer 102.

System bus 206 is also coupled to a hard drive interface 232, which interfaces with a hard drive 234. In a preferred embodiment, hard drive 234 populates a system memory 236, which is also coupled to system bus 206. Data that populates system memory 236 includes service provider server 202's operating system 238, which includes a shell 240 and a kernel 242. Shell 240 is incorporated in a higher level operating system layer and utilized for providing transparent user access to resources such as application programs 244, which include a browser 246, and a copy of developer selection system 148 described above, which can be deployed to client computer 102.

The hardware elements depicted in service provider server 202 are not intended to be exhaustive, but rather are representative to highlight essential components required by the present invention. For instance, service provider server 202 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 202 performs all of the functions associated with the present invention (including execution of the developer selection system 148), thus freeing client computer 102 from using its resources.

With reference now to the Figures, and in particular to FIG. 3, there is depicted a block diagram of the automated developer selection system 148 for selecting a developer to fix a defect. The system 148 makes use of previous real-work statistics to select the appropriate developer to help more accurately determine a time-frame to fix the defect. The real-work statistics are obtained from a version control and defect tracking tool such as the ClearCase and ClearQuest version control and defect tracking tools. The system 148 presents a list of properly skilled and available developers to work on an identified defect change. The system 148 enables limiting a selection list to only those developers that are appropriate to fix a particular defect. The system 148 also enables expanding a search for developers to fix the defect to outside an immediate product group.

More specifically, the system includes a developer profile portion 310 and a code profile portion 312. The developer profile portion 310 and the code profile portion 312 provide inputs to a developer selection module 320. The developer selection module 320 provides an input to a developer suggestion module 330.

The developer profile portion 310 receives a plurality of developer inputs 340 and develops a developer profile 342. The code profile portion 312 receives a plurality of code inputs 350 and develops a code profile 352. The developer profile inputs 340 include a developer skillset, developer languages, developer environments, developer technology specialty, a calendar of developer availability, information regarding how many defects already in the queue of the developer, etc. The developer profile inputs 340 can also include statistical data on percentage of rejected, reworked, or resubmitted defects by the developer; a title and department of the developer; list of components on which work has recently been performed by the developer; a schedule of availability of the developer and a percentage of available time of the developer devoted to a current project. Thus, if a developer is on vacation or has no available time on this project, then the developer suggestion module 330 would not present the developer as a viable candidate.

The code profile inputs 350 include a skillset desirable for fixing the defect, a typical level of effort to fix similar defects in this area; environments in which the component resides, technology required to fix the component. The code profile inputs 350 can also include component statistical data such as number of tangles, bundles and code profiling statistics from static analysis tool metrics (such as Rational Code Review); current defect per lines of code statistics (using for example, information from the version control and defect tracking tool); change rate for the component (using information from the version control and defect tracking tool); average fix time for similar defects in this area (this information may be generated from days in active/work-in-progress statistics in the version control and defect tracking tool). The code profile inputs 350 can also include a sorted list of developers to modify code in reverse chronological order as well as pointers to other documents like such as test cases, regression suites, etc.

The data for the developer inputs and the code inputs may be automatically imported from actual work records within the version control and defect tracking tool. Additional information can be provided by an organization's directory and calendars/project schedules.

By providing the developer profiles 342 and the code profiles 352 to the developer selection module 320, the system 148 matches and searches for a list of developers able to fix the problem. The system 148 can also create additional search criteria to priority order the identified developers. The developers that are identified via the matching and searching are presented via the developer suggestion module 330.

A searcher can identify a search protocol for use within the developer selection module 320. For example for Component X, the searcher might want to follow the following protocol:

First check Kevin Mooney, David Scott and Joe Brown's availability;

If those specific developers are not available, check all the developers in Dept. A. Find a list of developers that have the appropriate skillset and availability.

If we can't find in Dept A, search Dept. B, C, D.

Search rules used by the system 148 are flexible. For example, a searcher might set the search rules to automatically identify the first available developer or to limit the results of the search to a pulldown list of the top 5-10 appropriate developers. Either way, because of the profile matches, the list displayed is only of the developers that are capable and available to fix the defect.

When the developer profiles 342 and code profiles 352 have been automatically collected (and periodically updated), the developer selection module 320. In one embodiment, a change request tool or defect management tool accesses the developer selection module 320 to automatically list the appropriate developers that can implement a desired change.

User profiles can pre-select selection criteria. For example, selection and search criteria might include: automatically select best match; manually list top five (or n number or top candidates); include candidates that match at x % (for instance 100% match, 90% or above, etc.); first search for Person X, Y, Z and if not available, search Department X side, and if no match, search etc. (flexible search protocol rules).

Just like sports use previous performance results to create Batting Averages and Athletic statistics, the system 148 can use real performance/coding/testing data to automatically build talent profiles via developer information. This developer information can then be used to automatically provide talent sheets based on the particular change request order.

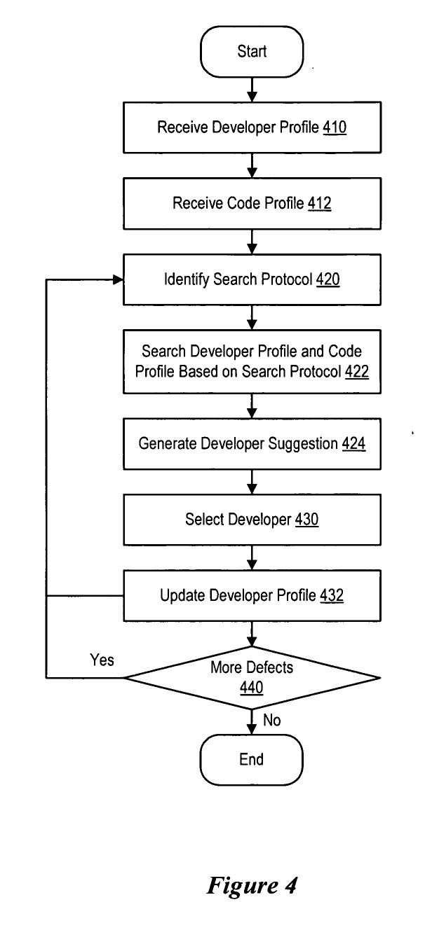

FIG. 4 shows a flow chart of the operation of the automated system for selecting a developer to fix a defect. More specifically, the automated system 148 starts operation by receiving developer profile information at step 410 and code profile information at step 412. Next, a user wishing to identify a developer to fix a defect identifies a search protocol at step 420. The developer selection module 320 then searches a database containing the developer profile information and the code profile information based upon the search protocol at step 422. Next the developer suggestion module 330 generates developer suggestions based upon the search protocol and the developer and code information at step 424. A user of the automated system 148 then selects a developer from one or more identified developers at step 430. After the developer is selected, then the corresponding developer profile is updated to reflect a new assignment at step 432. The system then determines whether there are any remaining defects to be assigned at step 440. If there are remaining defects to be assigned, then a new search protocol is identified at step 420. If there are not remaining defects to be assigned, then the operation completed.

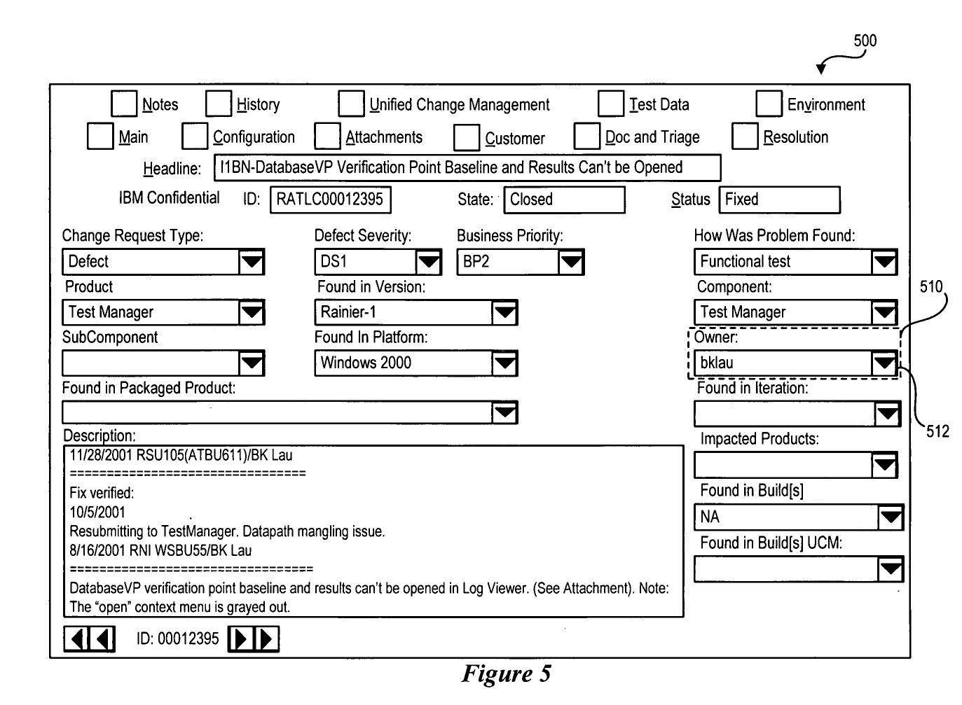

FIG. 5 shows an example screen presentation of the automated system 148 for selecting a developer to fix a defect. More specifically, the screen presentation 500 includes a developer identification portion 510 via which a suggested developer for fixing a defect is identified to a user to the automated system 148. Additional developers may be presented by actuating the arrow 512 to display a pull down menu.

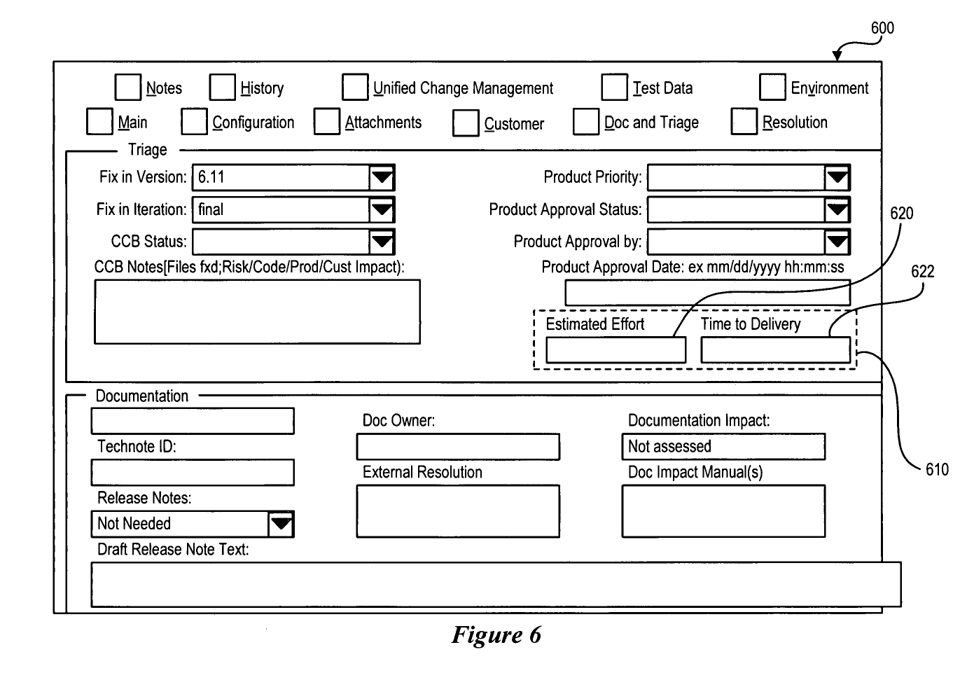

FIG. 6 shows example screen presentation 600 of the automated system 148 for inputting search criteria. The screen presentation 600 might be within a defect management tool screen presentation that includes a search criteria portion 610. The search criteria portion 610 enables a user to provide search criteria input to the automated system 148. More specifically, when performing a triage function, then a search protocol may be input into the automated system 148 to start a search for recommended developers. As part of the search protocol, estimated effort information 620 and time for delivery information 622 may be input to be used with the developer profile information and code profile information in developing a suggestion for a developer or developers for fixing the defect. So for example, if an estimated effort was greater than a particular developer's available time, then this developer would not be presented as a suggested developer. Also for example, if a time for delivery was during a time that a particular developer was on vacation or otherwise unavailable, then this developer would not be presented as a suggested developer.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, the method described herein, and in particular as shown and described in FIGS. 3-6 can be deployed as a process software from service provider server a deployment server 202 shown in FIG. 2) to client computer a client computer 102 shown in FIG. 1).

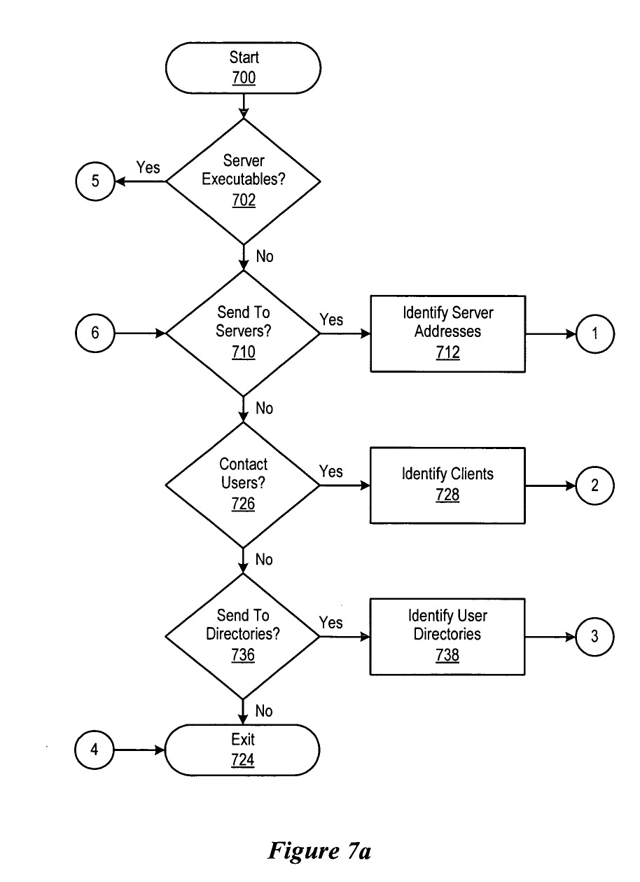

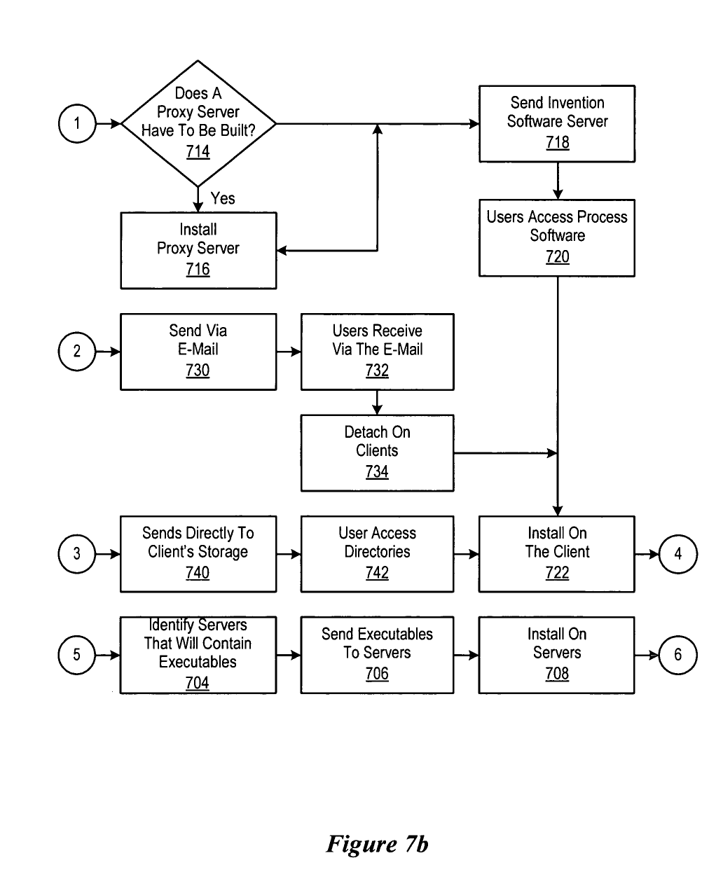

Referring then to FIG. 7, step 700 begins the deployment of the process software. The first thing is to determine if there are any programs that will reside on a server or servers when the process software is executed (query block 702). If this is the case, then the servers that will contain the executables are identified (block 704). The process software for the server or servers is transferred directly to the servers' storage via File Transfer Protocol (FTP) or some other protocol or by copying though the use of a shared file system (block 706). The process software is then installed on the servers (block 708).

Next, a determination is made on whether the process software is to be deployed by having users access the process software on a server or servers (query block 710). If the users are to access the process software on servers, then the server addresses that will store the process software are identified (block 712).

A determination is made if a proxy server is to be built (query block 714) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 716). The process software is sent to the servers either via a protocol such as FTP or it is copied directly from the source files to the server files via file sharing (block 718). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 720). Another embodiment is to have the servers automatically copy the process software to each client and then run the installation program for the process software at each client computer. The user executes the program that installs the process software on his client computer (block 722) then exits the process (terminator block 724).

In query step 726, a determination is made whether the process software is to be deployed by sending the process software to users via e-mail. The set of users where the process software will be deployed are identified together with the addresses of the user client computers (block 728). The process software is sent via e-mail to each of the users' client computers (block 730). The users then receive the e-mail (block 732) and then detach the process software from the e-mail to a directory on their client computers (block 734). The user executes the program that installs the process software on his client computer (block 722) then exits the process (terminator block 724).

Lastly, a determination is made on whether to the process software will be sent directly to user directories on their client computers (query block 736). If so, the user directories are identified (block 738). The process software is transferred directly to the user's client computer directory (block 740). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 742). The user executes the program that installs the process software on his client computer (block 722) and then exits the process (terminator block 724).

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as a leased line, the VPN uses “virtual” connections routed through the Internet from the company's private network to the remote site or employee. Access to the software via a VPN can be provided as a service by specifically constructing the VPN for purposes of delivery or execution of the process software (i.e., the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling, which is the process of placing an entire packet within another packet and sending it over a network. The protocol of the outer packet is understood by the network and both points, called tunnel interfaces, where the packet enters and exits the network.

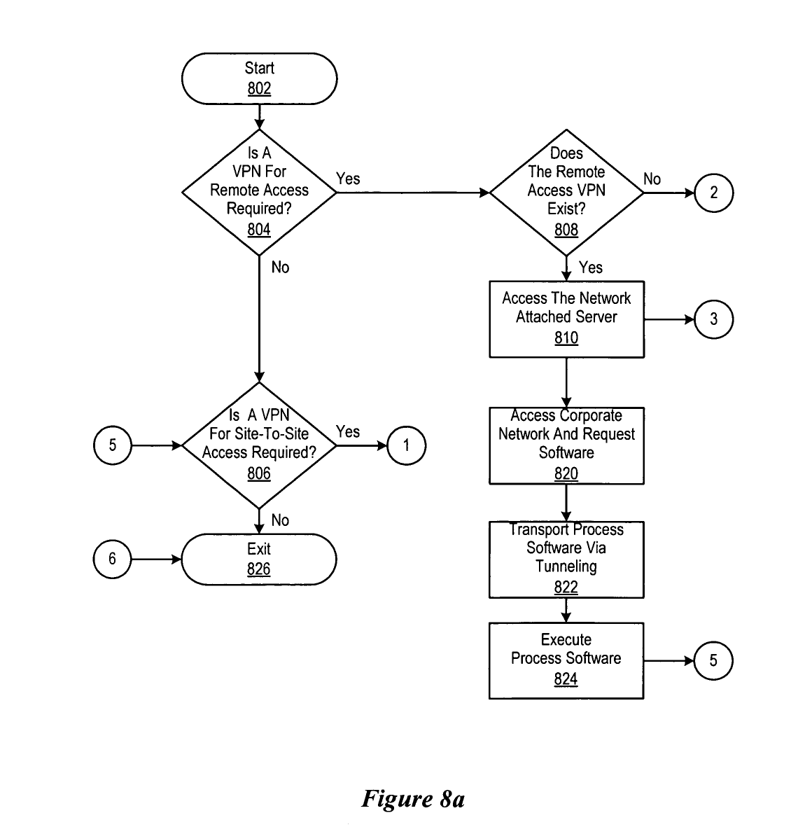

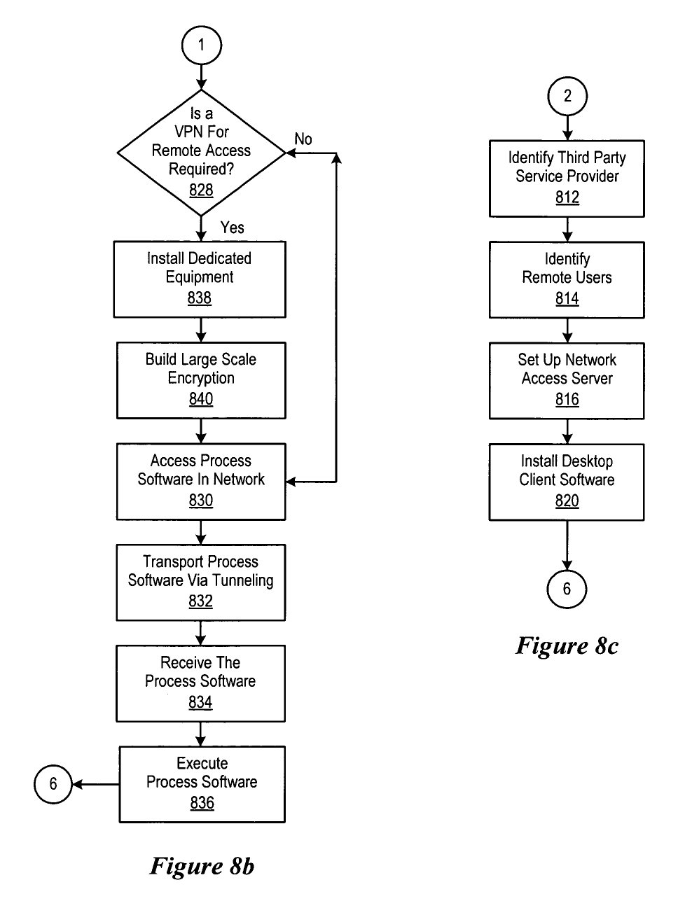

The process for such VPN deployment is described in FIG. 8. Initiator block 802 begins the Virtual Private Network (VPN) process. A determination is made to see if a VPN for remote access is required (query block 804). If it is not required, then proceed to query block 806. If it is required, then determine if the remote access VPN exists (query block 808).

If a VPN does exist, then proceed to block 810. Otherwise, identify a third party provider that will provide the secure, encrypted connections between the company's private network and the company's remote users (block 812). The company's remote users are identified (block 814). The third party provider then sets up a network access server (NAS) (block 816) that allows the remote users to dial a toll free number or attach directly via a broadband modem to access, download and install the desktop client software for the remote-access VPN (block 818).

After the remote access VPN has been built or if it been previously installed, the remote users can access the process software by dialing into the NAS or attaching directly via a cable or DSL modem into the NAS (block 810). This allows entry into the corporate network where the process software is accessed (block 820). The process software is transported to the remote user's desktop over the network via tunneling. That is, the process software is divided into packets and each packet including the data and protocol is placed within another packet (block 822). When the process software arrives at the remote user's desktop, it is removed from the packets, reconstituted and then is executed on the remote user's desktop (block 824).

A determination is then made to see if a VPN for site to site access is required (query block 806). If it is not required, then proceed to exit the process (terminator block 826). Otherwise, determine if the site to site VPN exists (query block 828). If it does not exist, then proceed to block 830. Otherwise, install the dedicated equipment required to establish a site to site VPN (block 838). Then build the large scale encryption into the VPN (block 840).

After the site to site VPN has been built or if it had been previously established, the users access the process software via the VPN (block 830). The process software is transported to the site users over the network via tunneling (block 832). That is the process software is divided into packets and each packet including the data and protocol is placed within another packet (block 834). When the process software arrives at the remote user's desktop, it is removed from the packets, reconstituted and is executed on the site user's desktop (block 836). The process then ends at terminator block 826.

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

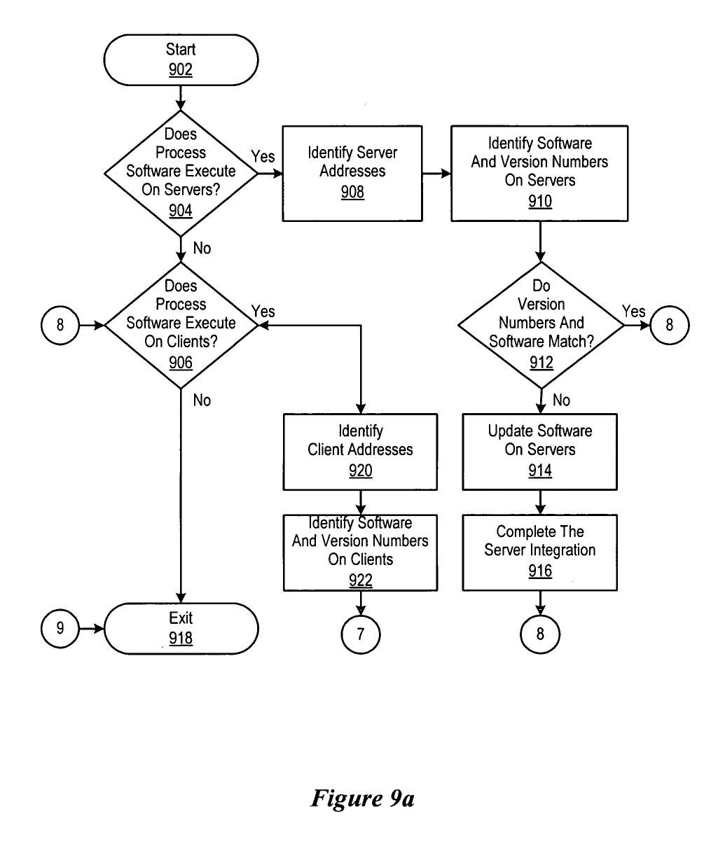

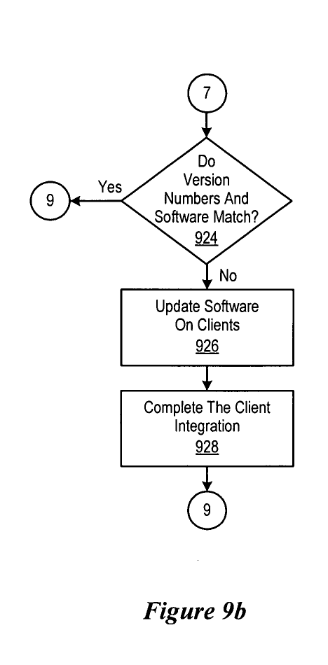

For a high-level description of this process, reference is now made to FIG. 9. Initiator block 902 begins the integration of the process software. The first tiling is to determine if there are any process software programs that will execute on a server or servers (block 904). If this is not the case, then integration proceeds to query block 906. If this is the case, then the server addresses are identified (block 908). The servers are checked to see if they contain software that includes the operating system (OS), applications, and network operating systems (NOS), together with their version numbers, which have been tested with the process software (block 910). The servers are also checked to determine if there is any missing software that is required by the process software in block 910.

A determination is made is the version numbers match the version numbers of OS, applications and NOS that have been tested with the process software (block 912). If all of the versions match and there is no missing required software the integration continues in query block 906.

If one or more of the version numbers do not match, then the unmatched versions are updated on the server or servers with the correct versions (block 914). Additionally, if there is missing required software, then it is updated on the server or servers in the step shown in block 914. The server integration is completed by installing the process software (block 916).

The step shown in query block 906, which follows either the steps shown in block 904, 912 or 916 determines if there are any programs of the process software that will execute on the clients. If no process software programs execute on the clients, the integration proceeds to terminator block 918 and exits. If this not the case, then the client addresses are identified as shown in block 920.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 922.

A determination is made is the version numbers match the version numbers of OS, applications and NOS that have been tested with the process software (query block 924). If all of the versions match and there is no missing required software, then the integration proceeds to terminator block 918 and exits.

If one or more of the version numbers do not match, then the unmatched versions are updated on the clients with the correct versions (block 926). In addition, if there is missing required software, then it is updated on the clients (also block 926). The client integration is completed by installing the process software on the clients (block 928). The integration proceeds to terminator block 918 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions, etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

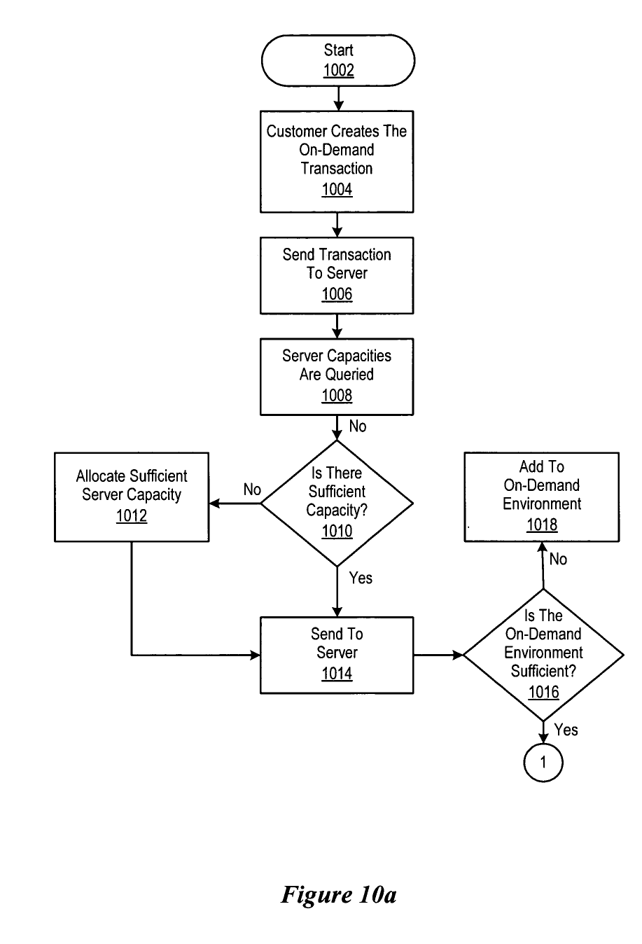

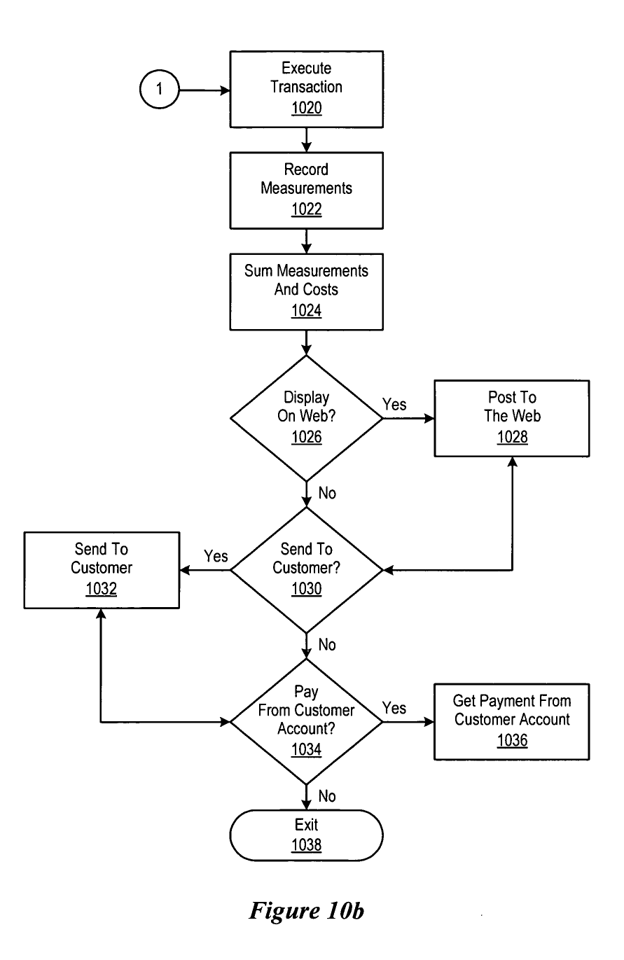

With reference now to FIG. 10, initiator block 1002 begins the On Demand process. A transaction is created than contains the unique customer identification, the requested service type and any service parameters that further specify the type of service (block 1004). The transaction is then sent to the main server (block 1006). In an On Demand environment the main server can initially be the only server, then as capacity is consumed, other servers are added to the On Demand environment.

The server central processing unit (CPU) capacities in the On Demand environment are queried (block 1008). The CPU requirement of the transaction is estimated, then the servers available CPU capacity in the On Demand environment are compared to the transaction CPU requirement to see if there is sufficient CPU available capacity in any server to process the transaction (query block 1010). If there is not sufficient server CPU available capacity, then additional server CPU capacity is allocated to process the transaction (block 1012). If there was already sufficient available CPU capacity then the transaction is sent to a selected server (block 1014).

Before executing the transaction, a check is made of the remaining On Demand environment to determine if the environment has sufficient available capacity for processing the transaction. This environment capacity consists of such things as, but not limited to, network bandwidth, processor memory, storage, etc. (block 1016). If there is not sufficient available capacity, then capacity will be added to the On Demand environment (block 1018). Next, the required software to process the transaction is accessed, loaded into memory, then the transaction is executed (block 1020).

The usage measurements are recorded (block 1022). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 1024).

If the customer has requested that the On Demand costs be posted to a web site (query block 1026), then they are posted (block 1028). If the customer has requested that the On Demand costs be sent via e-mail to a customer address (query block 1030), then these costs are sent to the customer (block 1032). If the customer has requested that the On Demand costs be paid directly from a customer account (query block 1034), then payment is received directly from the customer account (block 1036). The On Demand process is then exited at terminator block 1038.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDAs), telephones, and any other system capable of processing, transmitting, receiving, capturing and/or storing data.

What is claimed is:

1. A computer-implementable method comprising:
generating a developer profile;
generating a code profile;
identifying a defect within a component; and
automatically selecting a developer for fixing the defect within a component based upon the developer profile and the code profile.

2. The computer-implementable method of claim 1 wherein:
the developer profile includes information relating to previous real-work statistics of a developer.

3. The computer-implementable method of claim 1 wherein:
the automatically selecting includes determining a time-frame to fix the defect.

4. The computer-implementable method of claim 1 wherein:
the automatically selecting limits a selection list to only those developers that are appropriate to fix a particular defect based upon the developer profile and the code profile.

5. The computer-implementable method of claim 1 wherein:
the developer profile includes information relating to at least one of: a developer skillset, developer languages, developer environments, developer technology specialty, a calendar of developer availability, information regarding how many defects already in a defect queue of the developer, statistical data on percentage of rejected, reworked, or resubmitted defects, a title and department of the developer, a list of components on which work has recently been performed by the developer, a schedule of availability of the developer and a percentage of available time of the developer devoted to a current project.

6. The computer-implementable method of claim 1 wherein:
the code profile includes information relating to at least one of a skillset desirable for fixing the defect, a typical level of effort to fix similar defects; environments in which the defect resides, technology required to fix the defect, statistical data for the code in which the defect resides, current defect per lines of code statistics, change rate for the code, average fix time for similar defects, a list of developers who modified code where the defect resides.

7. A system comprising:
a processor;
a data bus coupled to the processor; and
a computer-usable medium embodying computer program code, the computer-usable medium being coupled to the data bus, the computer program code comprising instructions executable by the processor and configured for:
generating a developer profile;
generating a code profile;
identifying a defect within a component; and
automatically selecting a developer for fixing the defect within a component based upon the developer profile and the code profile.

8. The system of claim 7 wherein:
the developer profile includes information relating to previous real-work statistics of a developer.

9. The system of claim 7 wherein:
the automatically selecting includes determining a time-frame to fix the defect.

10. The system of claim 7 wherein:
the automatically selecting limits a selection list to only those developers that are appropriate to fix a particular defect based upon the developer profile and the code profile.

11. The system of claim 7 wherein:
the developer profile includes information relating to at least one of: a developer skillset, developer languages, developer environments, developer technology specialty, a calendar of developer availability, information regarding how many defects already in a defect queue of the developer, statistical data on percentage of rejected, reworked, or resubmitted defects, a title and department of the developer, a list of components on which work has recently been performed by the developer, a schedule of availability of the developer and a percentage of available time of the developer devoted to a current project.

12. The system of claim 7 wherein:
the code profile includes information relating to at least one of a skillset desirable for fixing the defect, a typical level of effort to fix similar defects; environments in which the defect resides, technology required to fix the defect, statistical data for the code in which the defect resides, current defect per lines of code statistics, change rate for the code, average fix time for similar defects, a list of developers who modified code where the defect resides.

13. A computer-usable medium embodying computer program code, the computer program code comprising computer executable instructions configured for:
generating a developer profile;
generating a code profile;
identifying a defect within a component; and
automatically selecting a developer for fixing the defect within a component based upon the developer profile and the code profile.

14. The computer-usable medium of claim 13 wherein:
the developer profile includes information relating to previous real-work statistics of a developer.

15. The computer-usable medium of claim 13 wherein:
the automatically selecting includes determining a time-frame to fix the defect.

16. The computer-usable medium of claim 13 wherein:
the automatically selecting limits a selection list to only those developers that are appropriate to fix a particular defect based upon the developer profile and the code profile.

17. The computer-usable medium of claim 13 wherein:
the developer profile includes information relating to at least one of: a developer skillset, developer languages, developer environments, developer technology specialty, a calendar of developer availability, information regarding how many defects already in a defect queue of the developer, statistical data on percentage of rejected, reworked, or resubmitted defects, a title and department of the developer, a list of components on which work has recently been performed by the developer, a schedule of availability of the developer and a percentage of available time of the developer devoted to a current project.

18. The computer-usable medium of claim 13 wherein:
the code profile includes information relating to at least one of a skillset desirable for fixing the defect, a typical level of effort to fix similar defects; environments in which the defect resides, technology required to fix the defect, statistical data for the code in which the defect resides, current defect per lines of code statistics, change rate for the code, average fix time for similar defects, a list of developers who modified code where the defect resides.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
